(19) United States
(12) Patent Application Publication
(10) Pub. No.: US 2026/0223193 A1
(43) Pub. Date: Jul. 30, 2026

(54) RANDOM ACCESS PROCEDURE

(71) Applicant: Nokia Technologies Oy, Espoo (FI)

(72) Inventors: Nitin MANGALVEDHE, Naperville, IL (US); Rapeepat RATASUK, Naperville, IL (US)

(21) Appl. No.: 19/148,916

(22) PCT Filed: Feb. 1, 2024
(86) PCT No.: PCT/EP2024/052530

§ 371 Date: Jul. 17, 2025

Related U.S. Application Data
(60) Provisional application No. 63/485,309, filed on Feb. 16, 2023.

(51) Int. Cl. H04W 74/0833; H04B 17/309; H04W 74/04

(52) U.S. Cl. CPC H04W 74/0833; H04B 17/346; H04W 74/04

(57) ABSTRACT

Embodiments of the present disclosure relate to a random access procedure. A terminal device obtains, a parameter for determining a minimum time between reception of Message 2 (Msg2) and transmission of Message 3 (Msg3) in a random access procedure between the terminal device and a network device. Then, the terminal device determines the minimum time based on the parameter. Moreover, the terminal device performs the random access procedure based on the minimum time. As a result, it is possible to control access latency and improve system access performance.

### FIELD

Various example embodiments relate to the field of telecommunication and in particular, to methods, devices, apparatuses, and computer readable storage media for a random access procedure.

### BACKGROUND

In communication technologies, there is a constant evolution ongoing in order to provide efficient and reliable solutions for utilizing wireless communication networks. Currently, efforts have been made to develop 5th generation (5G) or 5G advance wireless system. The new wireless systems can support various types of service applications for terminal devices.

In the current wireless system, to facilitate complexity reduction and thus save power consumption, reduced capability (RedCap) (and its enhanced or evolved version (for example, known as eRedCap)) user equipment (UE) has been proposed. Compared to a legacy UE, the RedCap UE has lower capabilities, for example, in terms of device bandwidth, an antenna configuration, a downlink multiple input multiple output (MIMO) support, a duplex operation, a maximum modulation, a peak data rate, etc. However, there are still some open problems for the RedCap UE that will be studied in the near future.

### SUMMARY

In general, example embodiments of the present disclosure provide a solution related to a random access procedure.

In a first aspect, there is provided a terminal device. The terminal device comprises at least one processor and at least one memory storing instructions that, when executed by the at least one processor, cause the terminal device at least to: obtain a parameter for determining a minimum time between reception of Message 2, Msg2, and transmission of Message 3, Msg3, in a random access procedure between the terminal device and a network device; determine the minimum time based on the parameter; and perform the random access procedure based on the minimum time.

In a second aspect, there is provided a network device. The network device comprises at least one processor and at least one memory storing instructions that, when executed by the at least one processor, cause the network device at least to: determine a parameter for at least one terminal device to determine a minimum time between Message 2, Msg2, and Message 3, Msg3, in a random access procedure between the at least one terminal device and the network device; and transmit the parameter to the at least one terminal device.

In a third aspect, there is provided a method implemented at a terminal device. The method comprises obtaining a parameter for determining a minimum time between reception of Message 2, Msg2, and transmission of Message 3, Msg3, in a random access procedure between the terminal device and a network device; determining the minimum time based on the parameter; and performing the random access procedure based on the minimum time.

In a fourth aspect, there is provided a method implemented at a network device. The method comprises determining a parameter for at least one terminal device to determine a minimum time between Message 2, Msg2, and Message 3, Msg3, in a random access procedure between the at least one terminal device and the network device; and transmitting the parameter to the at least one terminal device.

In a fifth aspect, there is provided an apparatus. The apparatus comprises means for obtaining, at a terminal device, a parameter for determining a minimum time between reception of Message 2, Msg2, and transmission of Message 3, Msg3, in a random access procedure between the terminal device and a network device; determining the minimum time based on the parameter; and performing the random access procedure based on the minimum time.

In a sixth aspect, there is provided an apparatus. The apparatus comprises means for determining, at a network device, a parameter for at least one terminal device to determine a minimum time between Message 2, Msg2, and Message 3, Msg3, in a random access procedure between the at least one terminal device and the network device; and transmitting the parameter to the at least one terminal device.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to perform at least the method according to any one of the above third to fourth aspect.

In a ninth aspect, there is provided a terminal device. The terminal device comprises obtaining circuitry configured to obtain a parameter for determining a minimum time between reception of Message 2, Msg2, and transmission of Message 3, Msg3, in a random access procedure between the terminal device and a network device; determining circuitry configured to determine the minimum time based on the parameter; and performing circuitry configured to perform the random access procedure based on the minimum time.

In a tenth aspect, there is provided a network device. The network device comprises determining circuitry configured to determine a parameter for at least one terminal device to determine a minimum time between Message 2, Msg2, and Message 3, Msg3, in a random access procedure between the at least one terminal device and the network device; and transmitting circuitry configured to transmit the parameter to the at least one terminal device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example environment in which example embodiments of the present disclosure can be implemented;

FIG. 2 illustrates a signaling flow between a terminal device and a network device according to some example embodiments of the present disclosure;

FIG. 3 illustrates an example communication process between a UE and a gNB according to some example embodiments of the present disclosure;

FIG. 4 illustrates a flowchart of a method implemented at a terminal device according to some embodiments of the present disclosure;

FIG. 5 illustrates a flowchart of a method implemented at a network device according to some embodiments of the present disclosure;

FIG. 6 illustrates a simplified block diagram of a device that is suitable for implementing some example embodiments of the present disclosure; and

FIG. 7 illustrates a block diagram of an example of a computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a New Radio (NR) NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As described above, to facilitate complexity reduction and thus save power consumption, the RedCap UE has been proposed. Some discussions about the RedCap UE have been made in release 17 (Rel-17) and release 18 (Rel-18).

In Rel-18, a work item on enhanced support of reduced capability NR devices (RP-223544) is specifying support for further complexity reduction of RedCap devices with baseband (BB) bandwidth reduction to 5 MHz for a physical downlink shared channel (PDSCH) and a physical uplink shared channel (PUSCH) only. The RF bandwidth for Rel-18 RedCap devices is the same as that for Rel-17 RedCap devices, i.e., 20 MHz. Furthermore, the other physical channels and signals are still allowed to use a bandwidth part (BWP) up to the 20 MHz maximum UE RF+BB bandwidth.

In a radio access network workgroup 1 (RAN1) #111, the following agreements were made.

```
Agreement
For UE BB bandwidth reduction, for PUSCH, down-select between the following options for the
maximum number of PRBs that the UE can transmit per slot or per hop, if applicable:
  • Option 3: 25 PRBs for 15 kHz SCS and 12 PRBs for 30 kHz SCS
  • Option 4: 25 PRBs for 15 kHz SCS and 11 PRBs for 30 kHz SCS
For UE BB bandwidth reduction, for PDSCH (for both unicast and broadcast), down-select between
the following options for the maximum number of PRBs that the UE can process per slot:
  • Option 3: 25 PRBs for 15 kHz SCS and 12 PRBs for 30 kHz SCS
  • Option 4: 25 PRBs for 15 kHz SCS and 11 PRBs for 30 kHz SCS
Same option will be selected for both PDSCH and PUSCH.
Agreement
For UE BB bandwidth reduction, for RAR (PDSCH) to Rel-18 RedCap UEs, the scheduling of
RAR PDSCH is allowed to be larger than the maximum number of unicast PRBs that the UE can
process per slot.
  • When the scheduling of RAR PDSCH is within the maximum number of unicast PRBs
  that the UE can process per slot, the legacy time between RAR reception and Msg3
  transmission (not smaller than N_{T,1} + N_{T,2} + 0.5 ms) is applied.
  • When the scheduling of RAR PDSCH is larger than the maximum number of unicast
  PRBs that the UE can process per slot,
    ○ The UE receives the RAR and correspondingly transmits Msg3 if the TDRA
    for Msg3 in UL grant in RAR indicates that the time between RAR reception
    and Msg3 transmission is NOT smaller than N_{T,1} + N_{T,2} + 0.5 + X ms.
      • FFS: value(s) of X
    ○ Otherwise, the UE behavior is up to the UE implementation.
  • Note: it does not mean early indication is needed
  • Note: it will not be used as example for unicast PDSCH
```

The first agreement listed above provides the options under the consideration for the maximum number of physical resource blocks (PRBs) of PDSCH that the UE can process per slot. The second agreement on the other hand allows for the number of PRBs used for scheduling random access response (RAR) (i.e. Message 2 (Msg2)) to exceed this maximum number of PRBs with the understanding that the RAR can still be processed for decoding but will take longer time than the time needed by a legacy UE. The second agreement thus allows for an extension of the minimum time between the RAR and the Message 3 (Msg3) scheduled by the RAR for Rel-18 RedCap UEs, providing the UEs more time to decode the RAR such that they will be able to transmit the Msg3 in the scheduled resources. The extension is supported through the parameter X noted in the second agreement.

In addition, the work item also includes an objective to support additional separate early indication(s) for the Rel-18 RedCap UEs. As in Rel-17, an early indication based on the Message 1 (Msg1) and Msg3 are supported, the same methods are likely to be extended for an early indication of Rel-18 RedCap UEs.

A simple way to define the parameter X is to specify a single fixed value of the parameter X. With the approach of defining the single fixed value of the parameter X, the single value that is to be specified needs to be designed for the worst case. For example, if the UE may process only x PRBs per slot and the RAR may be scheduled using y>x PRBs, where, e.g., y is the number of PRBs corresponding to the maximum transmission bandwidth with the subcarrier spacing (SCS) used corresponding to 20 MHz RF bandwidth, then total processing time for the Rel-18 RedCap UE may be [y/x] slots. Therefore, the value of X may be defined to be the time duration corresponding to [y/x]−1 slots. Thus, it can be seen that for the approach of defining a single fixed value of the parameter X, the disadvantage is the lack of scheduling flexibility.

The gNB can thus be expected to schedule the Msg3 with a gap that satisfies extension of the minimum time by this value of the parameter X. That is, if the actual gap (scheduling delay) is less than this extended value, the UE behavior is left up to its implementation. Therefore, the UE is not required to be able to transmit the Msg3. Furthermore, since the RAR is scheduled to be received by UEs at the cell edge, the gap may be higher than what many Rel-18 RedCap UEs with good signal-to-interference-plus-noise ratio (SINR) conditions need to process the RAR and prepare Msg3 for transmission (because these UEs may be able to successfully decode the RAR by processing the RAR in fewer slots, i.e., using fewer received PRBs). Therefore, the access latency is unnecessarily increased for all these UEs.

On the other hand, fixing a smaller value of the parameter X can impact UEs that are not able to successfully decode the RAR and transmit the Msg3 with the smaller gap. These UEs may fall back on the legacy procedure to repeat the random access attempt. Thus, system access performance may be impacted when a large number of UEs are in poorer SINR conditions and need more time to process the RAR.

In view of the above, inventors have noted that the agreement leaves open the possibility of defining more than one value of the parameter X. Therefore, as of now, there is no effective way to specify the value of the parameter X or signal it to the UE.

According to embodiments of the present disclosure, there is provided a scheme for a random access procedure. With this scheme, a terminal device obtains a parameter for determining a minimum time between reception of Msg2 and transmission of Msg3 in a random access procedure between the terminal device and a network device. For example, the parameter may be obtained from the network device. As another example, the parameter may be a default value when the parameter is not obtained from the network device (e.g. the parameter is not configured or transmitted by the network device). Then, the terminal device determines the minimum time based on the parameter. Moreover, the terminal device performs the random access procedure based on the minimum time.

This scheme provides more flexibility for the minimum time between Msg2 and Msg3 without causing large implementation complexity at the terminal and network sides. In this way, it is possible to control access latency and improve system access performance.

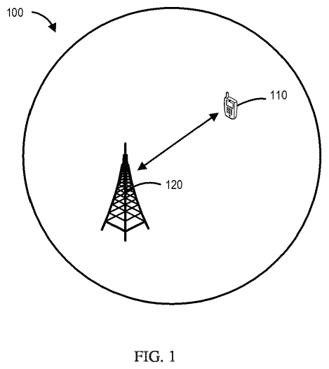

Principle and embodiments of the present disclosure will be described in detail below with reference to the accompanying drawings. Reference is first made to FIG. 1, which illustrates an example environment 100 in which example embodiments of the present disclosure can be implemented.

The environment 100, which may be a part of a communication network, comprises a terminal device 110 and a network device 120 communicating with each other or with other devices via each other.

The communication environment 100 may comprise any suitable number of devices and cells. In the communication environment 100, the terminal device 110 and the network device 120 can communicate data and control information with each other. A link from the network device 120 to the terminal device 110 is referred to as a downlink (DL), while a link from the terminal device 110 to the network device 120 is referred to as an uplink (UL).

It is to be understood that two devices are shown in the environment 100 for the purpose of illustration, without suggesting any limitation to the scope of the present disclosure. In some example embodiments, the environment 100 may comprise a further device to communicate with the terminal device 110 and network device 120.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connectivity (DC), and New Radio Unlicensed (NR-U) technologies.

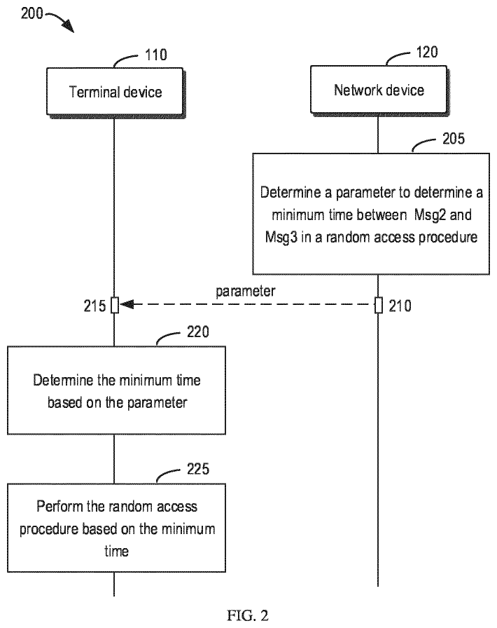

FIG. 2 illustrates a signaling flow 200 between the terminal device 110 and the network device 120 according to some example embodiments of the present disclosure. For the purpose of discussion, the signaling flow 200 will be described with reference to FIG. 1.

As shown in FIG. 2, the network device 120 determines (205) a parameter for at least one terminal device to determine a minimum time between Msg2 and Msg3, in a random access procedure between the at least one terminal device and the network device. For example, the minimum time may be between a last symbol of the Msg2 and a first symbol of the Msg3. The random access procedure may be performed between the at least one terminal device and the network device based on the minimum time. The least one terminal device may comprise the terminal device 110. The at least one terminal device (for example, the terminal device 110) may comprise a reduced capability terminal device, for example, a RedCap terminal device, or an eRedCap terminal device. As an example, the parameter may comprise the parameter X as described above, by which the minimum time between the Msg2 and the Msg3 is extended, for example, for the reduced capability terminal device.

In some example embodiments, the parameter may be determined from one or more pre-defined values. Alternatively or additionally, a pre-configured value, that is, a default value may be defined.

As an example, the parameter may be called “msg3-gapExtension-RedCap-r18”. The one or more pre-defined values may comprise the value 0 and value 1. Besides, a default value may be defined. In this case, the following description may be added for the parameter “msg3-gapExtension-RedCap-r18”.

msg3-gapExtension-RedCap-r18
value0 corresponds to 1 ms if the SCS is 15 kHz and to 0.5 ms if the SCS is 30 kHz. value1
corresponds to 2 ms if the SCS is 15 kHz and to 1 ms if the SCS is 30 kHz.
If this field is present, eRedCap UE uses this value to determine the minimum time between the last
symbol of a PDSCH reception conveying a RAR message with a RAR UL grant and the first symbol
of a corresponding PUSCH transmission scheduled by the RAR UL grant (see T# 38.213, clause
8.3)
If absent, eRedCap UE uses a value of 3 ms if the SCS is 15 kHz or a value of 1.5 ms if the SCS is
30 kHz.

In some example embodiments, the parameter may be selected from the one or more pre-defined values in a variety of ways. The network device 120 may configure the value of the parameter based on the evaluation of impact to terminal devices that may need a larger gap between Msg2 and Msg3.

For example, the one or more pre-defined values may comprise a first value. In the cases where there are a plurality of terminal devices, if the network device 120 determines that a number of terminal devices, among the plurality of terminal devices, that are unable to prepare a Msg3 after receiving the Msg2 within the minimum time, it may determine the parameter as the first value. In one example, the network device may configure the value of the parameter to be the first value if it determines, for example, based on previously reported measurements, that the number of terminal devices that may not be able to successfully decode Msg2 and transmit Msg3 with the minimum time extended by the parameter with the first value is less than the first threshold number.

For example, the one or more pre-defined values may comprise a second value. If the network device 120 determines that a difference between a cell-edge SINR and an SINR of receiving a Msg2 corresponding to processing a number of PRBs of the Msg2 based on the parameter is less than a threshold SINR, it may determine the parameter as the second value. As an example, the network device 120 may configure the parameter as the second value if it determines, for example, based on past reported measurements, that the difference between the cell-edge SINR and the SINR of receiving a RAR based on decoding a reduced number of PRBs corresponding to the minimum time extended by the parameter with the second value is less than the threshold SINR.

As shown in FIG. 2, the network device 120 may transmit (210) the parameter to the at least one terminal device. Accordingly, the terminal device 110 may obtain (215) the parameter from the network device 120. As an example, the parameter may be transmitted in a system information block (SIB). For example, a new higher layer configuration, for example, in SIB may be used for configuring the parameter by which the minimum time between the Msg2 and the scheduled Msg3 is extended, for example, for the RedCap terminal device. Alternatively or additionally, the parameter may be transmitted in any message configured by the higher layer.

As an example, the parameter called “msg3-gapExtension-RedCap-r18” that indicates the time duration by which the minimum time between Msg2 and Msg3 scheduled is extended may be configured in SIB1. For example, the value of the parameter “msg3-gapExtension-RedCap-r18” may be configured in the PUSCH-ConfigCommon information element in SIB1 as defined in the specification, for example, the third generation partnership project (3GPP) technical specification (TS) 38.331 as shown below.

For example, the search path may be configured as: SIB1→ServingCellConfigCommonSIB→UplinkConfigCommonSIB→(initialUplinkBWP-RedCap-r17)BWP-UplinkCommon-v1700→PUSCH-ConfigCommon.

A new entry description about the parameter “msg3-gapExtension-RedCap-r18” may be added in the PUSCH-ConfigCommon information element, as follows:

PUSCH-ConfigCommon information element

```
-- ASN1START
-- TAG-PUSCH-CONFIGCOMMON-START
PUSCH-ConfigCommon ::= SEQUENCE {
  groupHoppingEnabledTransformPrecoding ENUMERATED {enabled}
OPTIONAL, -- Need R
  pusch-TimeDomainAllocationList  PUSCH-TimeDomainResourceAllocationList
OPTIONAL, -- Need R
  msg3-DeltaPreamble INTEGER (−1..6)
OPTIONAL, -- Need R
  p0-NominalWithGrant   INTEGER (−202..24)
OPTIONAL, -- Need R
  msg3-gapExtension-RedCap-r18 ENUMERATED {value0, value 1}
OPTIONAL, -- Need S
  ...
}
-- TAG-PUSCH-CONFIGCOMMON-STOP
-- ASN1STOP
```

Alternatively, in addition to obtaining the parameter from the network device 120, the terminal device may obtain the parameter based on a pre-configured value. In this case, the configuration of the parameter may be optional, and a default value may be defined and used when the parameter is not configured. As an example, the terminal device 110 may determine the parameter as a default value if it determines that a field associated with the parameter is not present in the SIB1. In this case, as an example, 1 bit may support the default value and two other pre-defined values, for example, values 0 and 1 as defined for the parameter “msg3-gapExtension-RedCap-r18” stated above.

Based on the obtained parameter, the terminal device 110 determines (220) the minimum time between reception of Msg2 and transmission of Msg3 in a random access procedure between the terminal device 110 and a network device 120. Then, the terminal device 110 performs (225) the random access procedure based on the minimum time. For example, the minimum time may be between reception of a last symbol of the Msg2 and transmission of a first symbol of the Msg3.

In some example embodiments, the terminal device 110 may transmit a Msg1 to the network device 120. Accordingly, based on the reception of the Msg1, the network device 120 may schedule the Msg2 within a number of PRBs that the terminal device 110 is expected to be able to process and prepare the Msg3 for transmission within the minimum time, for example, based on the configured value of the parameter. The number of PRBs that the terminal device 110 is expected to be able to process may be considered as a PRB threshold when scheduling the Msg2. For example, if the parameter corresponds to n slots and the terminal device 110 may process B PRBs in a slot, then the terminal device 110 may be expected to be able to process (n+1)B PRBs of the received Msg2 (and subsequently prepare Msg3 for transmission).

In some example embodiments, the network device 120 may determine a number of PRBs for scheduling the Msg2 based on the parameter, such that a number of terminal devices, among the plurality of terminal devices, unable to prepare a Msg3 within the minimum time determined by the parameter is less than a second threshold number. As an example, the network device 120 may schedule the Msg2 using a certain number of PRBs that the terminal device may process with the minimum time extended by the parameter, if the network device 120 determines that the number of terminal devices that may not be able to successfully decode the Msg2 and transmit the Msg3 with the minimum time extended by the parameter is less than the second threshold number.

In some example embodiments, an early indication based on the Msg1 may be configured. In this case, the terminal device 110 may transmit, to the network device 120, in the Msg1, an indication that the terminal device 110 is a reduced capability terminal device. Then, the network device 120 may determine, for the terminal device 110, scheduling information associated with the reduced capability terminal device for transmission of the Msg3 based on the minimum time determined by the parameter. In this case, the terminal device may schedule a longer scheduling delay between reception of the Msg2 and transmission of the Msg3 (meeting the minimum time requirement for mandatory Msg3 transmission) only for the Msg3 from reduced capability terminal devices and a shorter scheduling delay (meeting the legacy minimum time requirement) for the Msg3 from legacy terminal devices.

Then, the network device 120 may transmit the Msg2 containing the scheduling information to the terminal device 110. The terminal device 110 may receive the RAR and processes it over multiple slots to obtain scheduling information for the transmission of the Msg3. Then, the terminal device 110 may determine the delay between the reception of the Msg2 and the transmission of the Msg3.

For example, if the terminal device 110 determines that the delay between the reception of the Msg2 and the transmission of the Msg3 is larger than or equal to the determined minimum time, it may transmit the Msg3 to the network device 120 based on the scheduling information.

As another example, if the terminal device 110 determines that the delay between the reception of the Msg2 and the transmission of the Msg3 is smaller than the determined minimum time, it may further determine whether preparation for the Msg3 is completed within the minimum time. If the terminal device 110 determines that the preparation for the Msg3 is completed within the minimum time, it may transmit the Msg3 to the network device 120 based on the scheduling information. The terminal device 110 may not transmit the Msg3, if it determines that the delay between the reception of the Msg2 and the transmission of the Msg3 is smaller than the determined minimum time. Alternatively or additionally, the terminal device 110 may not transmit the Msg3, if it determines that the delay between the reception of the Msg2 and the transmission of the Msg3 is smaller than the determined minimum time and the preparation for the Msg3 fails to be completed within the minimum time. That is, if the delay is smaller than the determined minimum time, the terminal device 110 may or may not transmit the Msg3.

As an example, descriptions about the use of the parameter “msg3-gapExtension-RedCap-r18” may be added in the specification, for example, TS 38.213, as follows.

The UE may assume a minimum time between the last symbol of a PDSCH reception conveying a RAR
message with a RAR UL grant and the first symbol of a corresponding PUSCH transmission scheduled
by the RAR UL grant is equal to N_{T,1} + N_{T,2} + 0.5 msec, where N_{T,1} is a time duration of N₁
symbols corresponding to a PDSCH processing time for UE processing capability 1 when additional
PDSCH DM-RS is configured, N_{T,2} is a time duration of N₂ symbols corresponding to a PUSCH
preparation time for UE processing capability 1 [6, TS 38.214] and, for determining the minimum time,
the UE considers that N₁ and N₂ correspond to the smaller of the SCS configurations for the PDSCH
and the PUSCH. For μ = 0, the UE assumes N_{1,0} = 14 [6, TS 38.214].
The eRedCap UE shall transmit Msg3 if the scheduling information in the RAR indicates a time between
the last symbol of a PDSCH reception conveying a RAR message with a RAR UL grant and the first
symbol of a corresponding PUSCH transmission scheduled by the RAR UL grant that is equal to at least
N_{T,1} + N_{T,2} + 0.5 + msg3-gapExtension-RedCap msec, where msg3-gapExtension-RedCap is defined
by higher layer configuration in [TS 38.331]. Otherwise, the UE behavior is based on UE
implementation.

In some example embodiments, if the network device 120 determines that a number of PRBs for scheduling a Msg2 for the terminal device 110 exceeds a PRB threshold for a Msg2 transmission, it may split the Msg2 into multiple Msg2 scheduled using small number of PRBs. The PRB threshold may be based on the parameter. The determination of the PRB threshold based on the parameter has been described above. The PRB threshold may be determined based on the implementations. Then, the network device 120 may transmit, to the terminal device 110, a plurality of Msg2 within a RAR window. In this case, accordingly, the terminal device 110 may receive, from the network device 120, a plurality of Msg2 within the RAR window.

In this way, a configurable extension of the minimum time between Msg2 and Msg3 is supported, for example, for the Rel-18 RedCap terminal devices. Thus, it is allowed to provide more flexibility for the minimum time between the Msg2 and Msg3 without causing large implementation complexity at the terminal and network sides. Therefore, it is possible to control access latency and improve system access performance.

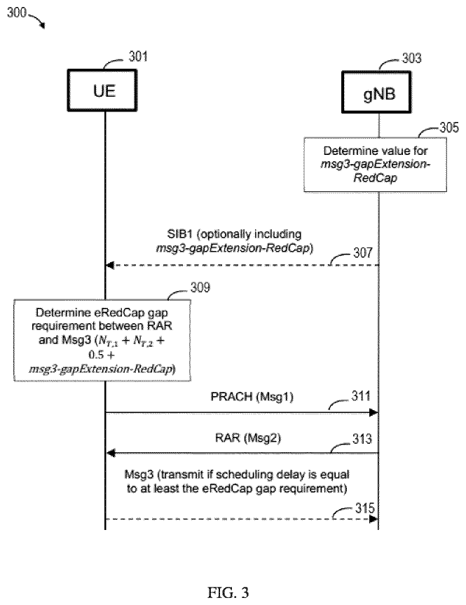

FIG. 3 illustrates a first example communication process 300 between a UE 301 and a gNB 303 according to some example embodiments of the present disclosure. In particular, FIG. 3 shows an example signaling diagram for downlink processing time indication. It would be appreciated that the process flow 300 may be considered as an example of the signaling flow 200 as shown in FIG. 2. Accordingly, the UE 301 may be an example of the terminal device 110, and the gNB 303 may be an example of the network device 120.

As shown in FIG. 3, at 305, the gNB 303 determines the value for the parameter “msg3-gapExtension-RedCap” for determining a minimum time between Msg2 and Msg3, for example, between a last symbol of the Msg2 and a first symbol of the Msg3, based on, e.g., cell measurement that provides information on how many UEs may be affected by configuring the parameter “msg3-gapExtension-RedCap” to each of the supported values. At 307, the gNB 303 transmits SIB1, which optionally includes the parameter “msg3-gapExtension-RedCap”.

Then, the UE 301 reads the SIB1 and determines the value of the parameter “msg3-gapExtension-RedCap” based on whether or not a field associated with the parameter “msg3-gapExtension-RedCap” is present in the SIB1. At 309, the UE 301 determines the minimum time (that is, the gap requirement) between the last symbol of Msg2 and the first symbol of Msg3, for which it is expected to transmit Msg3, (N_{T,1}+N_{T,2}+0.5+msg3-gapExtension-RedCap).

At 311, the UE 301 transmits the Msg1 to the gNB 303. At 313, the gNB 303 transmits the Msg2 to the UE 301. Then, the UE 301 receives the RAR and processes it over multiple slots to decode the Msg3 scheduling information that it contains. Further, the UE 301 determines the scheduling delay. At 315, if the scheduling delay is equal to at least the minimum time determined in operation 309, it may complete the preparation of Msg3 and transmit Msg3 in the scheduled resources according to the scheduling information. If the scheduling delay is less than the minimum time, the UE 301 may determine to transmit Msg3 if it is able to complete the preparation of Msg3 before the scheduled time according to the scheduling information.

Operations and features as described above with reference to FIG. 2 is likewise applicable to the process 300 and have similar effects. For the purpose of simplification, the details will be omitted.

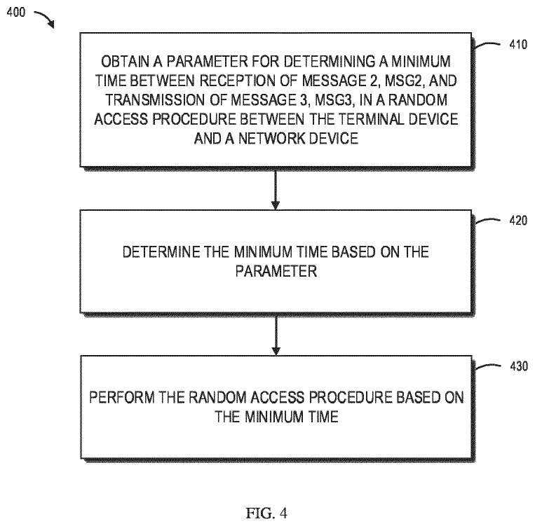

FIG. 4 illustrates a flowchart 400 of a method implemented at a terminal device according to some embodiments of the present disclosure. For the purpose of discussion, the method 400 will be described from the perspective of the terminal device 110 with reference to FIG. 1.

At block 410, the terminal device 110 obtains a parameter for determining a minimum time between reception of Message 2, Msg2, and transmission of Message 3, Msg3, in a random access procedure between the terminal device 110 and a network device 120. At block 420, the terminal device 110 determines the minimum time based on the parameter. At block 430, the terminal device 110 performs the random access procedure based on the minimum time.

In some example embodiments, the parameter may be obtained by receiving the parameter from the network device 120 in a system information block, SIB.

In some example embodiments, the parameter may be obtained by being configured as one of one or more pre-defined values.

In some example embodiments, the parameter may be a pre-configured value, and the parameter may be obtained based on not being configured.

In some example embodiments, to perform the random access procedure, the terminal device 110 may obtain, from a Msg2, scheduling information for transmission of a Msg3 at the terminal device 110. Moreover, the terminal device 110 may transmit the Msg3 to the network device 120 based on the scheduling information, based on determining that a delay between reception of the Msg2 and the transmission of the Msg3 is larger than or equal to the minimum time.

In some example embodiments, to perform the random access procedure, the terminal device 110 may obtain, from a Msg2 scheduling information for transmission of a Msg3 at the terminal device 110. The terminal device 110 may determine whether preparation for the Msg3 is completed within the minimum time, based on determining that a delay between reception of the Msg2 and the transmission of the Msg3 is smaller than the minimum time. Moreover, the terminal device 110 transmits the Msg3 to the network device 120, based on the scheduling information based on determining that the preparation for the Msg3 is completed within the minimum time.

In some example embodiments, the terminal device 110 may further receive, from the network device 120, a plurality of Msg2 within a random access response, RAR, window.

In some example embodiments, the terminal device 110 may be a reduced capability terminal device 110.

In some example embodiments, the minimum time may be between reception of a last symbol of the Msg2 and transmission of a first symbol of the Msg3.

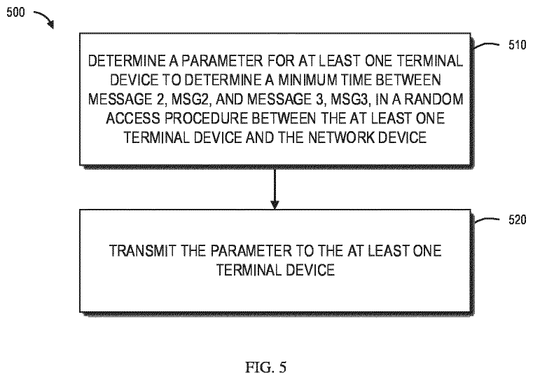

FIG. 5 illustrates a flowchart 500 of a method implemented at a network device according to some embodiments of the present disclosure. For the purpose of discussion, the method 500 will be described from the perspective of the network device 120 with reference to FIG. 1.

At block 510, the network device 120 determines a parameter for at least one terminal device 110 to determine a minimum time between Message 2, Msg2, and Message 3, Msg3, in a random access procedure between the at least one terminal device 110 and the network device 120. At block 520, the network device 120 transmits the parameter to the at least one terminal device 110.

In some example embodiments, the parameter may be transmitted in a system information block, SIB.

In some example embodiments, the parameter may be determined from one or more pre-defined values.

In some example embodiments, the one or more pre-defined values may comprise a first value, the at least one terminal device 110 may comprise a plurality of terminal devices. In this case, to determine the parameter, the network device 120 may determine the parameter as the first value, based on determining that a number of terminal device 110s among the plurality of terminal devices is less than a first threshold number, where the terminal device 110s among the plurality of terminal devices are unable to prepare a Msg3 after receiving the Msg2 within the minimum time.

In some example embodiments, the one or more pre-defined values may comprise a second value, and in this case, to determine the parameter, the network device 120 may determine the parameter as the second value, based on determining that a difference between a cell-edge signal-to-interference-plus-noise ratio, SINR, and an SINR of receiving a Msg2 is less than a threshold SINR, where receiving the Msg2 corresponds to processing a number of physical resource blocks, PRBs, of the Msg2 based on the parameter.

In some example embodiments, the at least one terminal device 110 may comprise a plurality of terminal devices, and in this case, the network device 120 may further determine a number of PRBs for scheduling a Msg2 based on the parameter, such that a number of terminal device 110s among the plurality of terminal devices is less than a second threshold number, where the terminal device 110s among the plurality of terminal devices are unable to prepare a Msg3 within the minimum time determined by the parameter.

In some example embodiments, the network device 120 may further transmit, to the terminal device 110, a plurality of Msg2 within a random access response, RAR, window, based on determining that a number of PRBs for scheduling a Msg2 for a terminal device 110 of the at least one terminal device 110s exceeds a PRB threshold for a Msg2 transmission, t.

In some example embodiments, the network device 120 may further receive, from a terminal device 110 of the at least one terminal device 110, an indication in Message 1, Msg1, that the terminal device 110 is a reduced capability terminal device 110. Moreover, the network device 120 may transmit, to the terminal device 110, within the Msg2, scheduling information associated with the reduced capability terminal device 110 for transmission of a Msg3 based on the minimum time determined by the parameter.

In some example embodiments, the minimum time may be between a last symbol of the Msg2 and a first symbol of the Msg3.

In some example embodiments, an apparatus capable of performing the method 400 (for example, the terminal device 110) may comprise means for performing the respective steps of the method 400. The means may be implemented in any suitable form. For example, the means may be implemented in a circuitry or software module.

In some example embodiments, the apparatus comprises means for obtaining a parameter for determining a minimum time between reception of Message 2, Msg2, and transmission of Message 3, Msg3, in a random access procedure between the terminal device and a network device; means for determining the minimum time based on the parameter; and means for performing the random access procedure based on the minimum time.

In some example embodiments, the parameter is obtained by receiving the parameter from the network device in a system information block, SIB.

In some example embodiments, the parameter is obtained by being configured as one of one or more pre-defined values.

In some example embodiments, the parameter is a pre-configured value, and the parameter is obtained based on not being configured.

In some example embodiments, the means for performing the random access procedure comprises means for obtaining, from a Msg2, scheduling information for transmission of a Msg3 at the terminal device; and means for based on determining that a delay between reception of the Msg2 and the transmission of the Msg3 is larger than or equal to the minimum time, transmitting the Msg3 to the network device based on the scheduling information.

In some example embodiments, the means for performing the random access procedure comprises means for obtaining, from a Msg2 scheduling information for transmission of a Msg3 at the terminal device; means for, based on determining that a delay between reception of the Msg2 and the transmission of the Msg3 is smaller than the minimum time, determine whether preparation for the Msg3 is completed within the minimum time; and means for, based on determining that the preparation for the Msg3 is completed within the minimum time, transmitting the Msg3 to the network device based on the scheduling information.

In some example embodiments, the apparatus further comprise means for receiving, from the network device, a plurality of Msg2 within a random access response, RAR, window.

In some example embodiments, the terminal device is a reduced capability terminal device.

In some example embodiments, the minimum time is between reception of a last symbol of the Msg2 and transmission of a first symbol of the Msg3.

In some embodiments, the apparatus further comprises means for performing other steps in some embodiments of the method 400. In some embodiments, the means comprises at least one processor and at least one memory including computer program code, the at least one memory and computer program code configured to, with the at least one processor, cause the performance of the apparatus.

In some example embodiments, an apparatus capable of performing the method 500 (for example, the network device 120) may comprise means for performing the respective steps of the method 500. The means may be implemented in any suitable form. For example, the means may be implemented in a circuitry or software module.

In some example embodiments, the apparatus comprises means for determining a parameter for at least one terminal device to determine a minimum time between Message 2, Msg2, and Message 3, Msg3, in a random access procedure between the at least one terminal device and the network device; and means for transmitting the parameter to the at least one terminal device.

In some example embodiments, the parameter is transmitted in a system information block, SIB.

In some example embodiments, the parameter is determined from one or more pre-defined values.

In some example embodiments, the one or more pre-defined values comprises a first value, the at least one terminal device comprises a plurality of terminal devices, and the means for determining the parameter comprises means for, based on determining that a number of terminal devices among the plurality of terminal devices is less than a first threshold number, determining the parameter as the first value, wherein the terminal devices among the plurality of terminal devices are unable to prepare a Msg3 after receiving the Msg2 within the minimum time.

In some example embodiments, the one or more pre-defined values comprises a second value, and the means for determining the parameter comprises means for, based on determining that a difference between a cell-edge signal-to-interference-plus-noise ratio, SINR, and an SINR of receiving a Msg2 is less than a threshold SINR, determining the parameter as the second value, wherein receiving the Msg2 corresponds to processing a number of physical resource blocks, PRBs, of the Msg2 based on the parameter.

In some example embodiments, the at least one terminal device comprises a plurality of terminal devices, and the apparatus further comprises means for determining a number of PRBs for scheduling a Msg2 based on the parameter, such that a number of terminal devices among the plurality of terminal devices is less than a second threshold number, wherein the terminal devices among the plurality of terminal devices are unable to prepare a Msg3 within the minimum time determined by the parameter.

In some example embodiments, the apparatus further comprises means for, based on determining that a number of PRBs for scheduling a Msg2 for a terminal device of the at least one terminal devices exceeds a PRB threshold for a Msg2 transmission, transmitting, to the terminal device, a plurality of Msg2 within a random access response, RAR, window.

In some example embodiments, the apparatus further comprises means for receiving, from a terminal device of the at least one terminal device, an indication in Message 1, Msg1, that the terminal device is a reduced capability terminal device; and means for transmitting, to the terminal device, within the Msg2, scheduling information associated with the reduced capability terminal device for transmission of a Msg3 based on the minimum time determined by the parameter.

In some example embodiments, the minimum time is between a last symbol of the Msg2 and a first symbol of the Msg3.

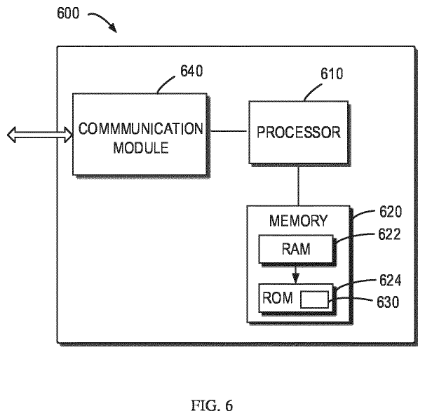

FIG. 6 illustrates a simplified block diagram of a device 600 that is suitable for implementing some example embodiments of the present disclosure. The device 600 may be provided to implement the communication device, for example, the terminal device 110, or the network device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIG. 2 and FIG. 3. The embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like.

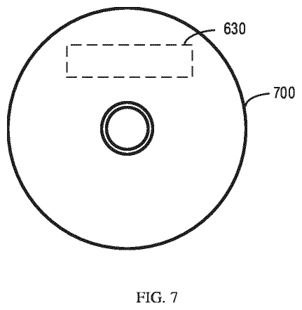

FIG. 7 illustrates a block diagram of an example of a computer readable medium 700 in accordance with some example embodiments of the present disclosure. The computer readable medium 700 has the program 630 stored thereon. It is noted that although the computer readable medium 700 is depicted in form of CD or DVD in FIG. 7, the computer readable medium 700 may be in any other form suitable for carry or hold the program 630.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to FIG. 4 or FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
obtain a parameter for determining a minimum time between reception of Message 2, Msg2, and transmission of Message 3, Msg3, in a random access procedure between the terminal device and a network device;
determine the minimum time based on the parameter; and
perform the random access procedure based on the minimum time.

2. The terminal device of claim 1, wherein the parameter is obtained by receiving the parameter from the network device in a system information block, SIB.

3. The terminal device of claim 1, wherein the parameter is obtained by being configured as one of one or more pre-defined values.

4. The terminal device of claim 1, wherein the parameter is a pre-configured value, and the parameter is obtained based on not being configured.

5. The terminal device of claim 1, wherein the terminal device is caused to perform the random access procedure by:
obtaining, from a Msg2, scheduling information for transmission of a Msg3 at the terminal device; and
based on determining that a delay between reception of the Msg2 and the transmission of the Msg3 is larger than or equal to the minimum time, transmitting the Msg3 to the network device based on the scheduling information.

6. The terminal device of claim 1, wherein the terminal device is caused to perform the random access procedure by:
obtaining, from a Msg2 scheduling information for transmission of a Msg3 at the terminal device;
based on determining that a delay between reception of the Msg2 and the transmission of the Msg3 is smaller than the minimum time, determine whether preparation for the Msg3 is completed within the minimum time; and
based on determining that the preparation for the Msg3 is completed within the minimum time, transmitting the Msg3 to the network device based on the scheduling information.

7. The terminal device of claim 1, wherein the terminal device is further caused to:
receive, from the network device, a plurality of Msg2 within a random access response, RAR, window.

8. The terminal device of claim 1, wherein the terminal device is a reduced capability terminal device.

9. The terminal device of claim 1, wherein the minimum time is between reception of a last symbol of the Msg2 and transmission of a first symbol of the Msg3.

10. A network device comprising:
at least one processor; and
at least one memory storing instructions that, when executed by the at least one processor, cause the network device at least to:
determine a parameter for at least one terminal device to determine a minimum time between Message 2, Msg2, and Message 3, Msg3, in a random access procedure between the at least one terminal device and the network device; and
transmit the parameter to the at least one terminal device.

11. The network device of claim 10, wherein the parameter is transmitted in a system information block, SIB.

12. The network device of claim 10, wherein the parameter is determined from one or more pre-defined values.

13. The network device of claim 12, wherein the one or more pre-defined values comprises a first value, the at least one terminal device comprises a plurality of terminal devices, and wherein the network device is caused to determine the parameter by:
based on determining that a number of terminal devices among the plurality of terminal devices is less than a first threshold number, determining the parameter as the first value, wherein the terminal devices among the plurality of terminal devices are unable to prepare a Msg3 after receiving the Msg2 within the minimum time.

14. The network device of claim 12, wherein the one or more pre-defined values comprises a second value, and wherein the network device is caused to determine the parameter by:
based on determining that a difference between a cell-edge signal-to-interference-plus-noise ratio, SINR, and an SINR of receiving a Msg2 is less than a threshold SINR, determining the parameter as the second value, wherein receiving the Msg2 corresponds to processing a number of physical resource blocks, PRBs, of the Msg2 based on the parameter.

15. The network device of claim 10, wherein the at least one terminal device comprises a plurality of terminal devices, and wherein the network device is further caused to:
determine a number of PRBs for scheduling a Msg2 based on the parameter, such that a number of terminal devices among the plurality of terminal devices is less than a second threshold number, wherein the terminal devices among the plurality of terminal devices are unable to prepare a Msg3 within the minimum time determined by the parameter.

16. The network device of claim 10, wherein the network device is further caused to:
based on determining that a number of PRBs for scheduling a Msg2 for a terminal device of the at least one terminal devices exceeds a PRB threshold for a Msg2 transmission, transmit, to the terminal device, a plurality of Msg2 within a random access response, RAR, window.

17. The network device of claim 10, wherein the network device is further caused to:
receive, from a terminal device of the at least one terminal device, an indication in Message 1, Msg1, that the terminal device is a reduced capability terminal device; and
transmit, to the terminal device, within the Msg2, scheduling information associated with the reduced capability terminal device for transmission of a Msg3 based on the minimum time determined by the parameter.

18. The network device of claim 10, wherein the minimum time is between a last symbol of the Msg2 and a first symbol of the Msg3.

19. A method comprising:
obtaining, at a terminal device, a parameter for determining a minimum time between reception of Message 2, Msg2, and transmission of Message 3, Msg3, in a random access procedure between the terminal device and a network device;
determining the minimum time based on the parameter; and
performing the random access procedure based on the minimum time.

20.-23. (canceled)
